(19) United States
(12) Patent Application Publication
(10) Pub. No.: US 2004/0176474 A1
(43) Pub. Date: Sep. 9, 2004

(54) Pest control compositions

(75) Inventor: Ron Frim, Haifa (IL)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Bromine Compounds Ltd., Beer-sheva (IL)

(21) Appl. No.: 10/796,237

(22) Filed: Mar. 9, 2004

Related U.S. Application Data
(62) Division of application No. 10/366,294, filed on Feb. 13, 2003.

(51) Int. Cl. A01N 29/02; A01N 43/40

(52) U.S. Cl. 514/745

(57) ABSTRACT

The stabilization of 3BP throughout its life-cycle is achieved via the use of azeotropic mixtures for dilution and prevention of shock or temperature sensitivity.

### CROSS REFERENCE TO RELATED APPLICATIONS

The present application is a divisional of U.S. application Ser. No. 10/366,294, filed on Feb. 13, 2003, the disclosure of which is incorporated by reference herein.

### FIELD OF THE INVENTION

The present invention relates to the field of fumigants and soil-borne pest control compositions. More particularly, the invention relates to such compositions that are free of methyl bromide and in general can replace methyl bromide as an effective fumigant against fungi, nematodes and other undesirable pathogens.

### BACKGROUND OF THE INVENTION

Methyl bromide is a highly effective fumigant and has been widely used for the control of soilborne pests. To date, there is no known substitute that has comparable efficacy, low cost, ease of use and wide availability. However, methyl bromide is an ozone depleting agent and therefore ecologically harmful (Montreal Protocol on Substances that Deplete the Ozone Layer. Article 2H: Methyl Bromide). As a result, the Environmental Protection Agency (EPA) has gradually reduced its production and by the year 2005, methyl bromide will be banned for certain uses in certain countries. Methyl bromide is also a toxic material, and human exposure to high concentrations can result in central nervous system and respiratory system failure.

Yates et al, “Propargyl Bromide—A Possible Chemical Alternative to Methyl Bromide for Pre-Plant Soil Fumigation”, USDA-AM Soil Physics and Pesticides Research Unit, 1998 indicates that propargyl bromide was used in the 1960's in a soil fumigant called Trizone, a combination of chloropicrin, methyl bromide and propargyl bromide. Propargyl bromide is 3-bromopropyne and is therefore sometimes designated as 3BP. The authors state that at the time no information existed on 3BP's behavior and safety in the environment. However, Trizone was not pursued because of its explosiveness and because of the manufacturing cost differential between propargyl bromide and methyl bromide. Noling et al, “Propargyl Bromide and Other Fumigants for Nematode Control”, University of Florida, Institute of Food & Agricultural Sciences, 2000, disclose several parameters that show the efficacy and environmental compatibility of propargyl bromide, including solubility, saturated vapor density, the Henry's Law constant, adsorption and degradation. However, propargyl bromide is highly flammable and shock sensitive and its vapors may form explosive mixtures with air, and this negative quality has so far prevented its extensive use as a fumigant. The hazardous character of propargyl bromide is well recognized and documented. Propargyl bromide is considered a shock sensitive material which may ignite spontaneously and decompose violently. A study for stabilization of propargyl bromide via dilution was published already in 1967 (see British Patent 1,132,417, “Explosion- and ignition-stable propargyl bromide”, and Coffee and Wheeler, “Explosibility and stabilization of propargyl bromide, Loss Prev. Symp., Houston, Tex., (1967)), in which the authors designated propargyl bromide as a shock and temperature sensitive material that under certain conditions may detonate.

However, the known solution to the sensitivity of the material did not provide a sufficient solution that diminishes the problem both in the liquid and in the vapor phase. Thus, in the vapor phase conditions can be created in which propargyl bromide is concentrated enough to cause explosion. One solution for this problem can be a formulation that will be constant both in the liquid and in the vapor state e.g. an azeotrope.

Some data on azeotropes of similar compounds to 3BP i.e. 3-bromopropene and 3-bromopropane are presented in the literature, as set forth in Table A below. No data was found on the azeotropes of propargyl bromide (3-bromopropyne-1).

TABLE A

| | | | Azeotrope, | % Component A |
|---|---|---|---|---|
| N | Component A, b.p. ° C. | Component B, b.p ° C. | b.p. ° C. | In Azeotrope |
| 1 | 3-Bromopropene 70.5 | Allyl alcohol, 97 | <69.2 | 92.0 |
| 2 | 3-Bromopropene 70.5 | Propyl alcohol, 97 | 69 | 90 |
| 3 | 3-Bromopropene 70.5 | iso-Propyl alcohol, 82 | 66 | 80 |
| 4 | 3-Bromopropene 70.5 | Methyl alcohol, 64 | 54 | 80 |
| 5 | 1-Bromopropane 71 | Propyl alcohol, 97 | 69.7 | 90-91 |
| 6 | 1-Bromopropane 71 | iso-Propyl alcohol, 82 | 66.7 | 79 |
| 7 | 1-Bromopropane 71 | tert. Butyl alcohol 82 | 68 | 88 |

As can be seen both 3-bromopropene and 3-bromopropane form azeotropes with alcohols.

It is therefore an object of the present invention to provide a formulation for a fumigant that includes propargyl bromide in an active amount, and yet is not impact sensitive.

It is another object of the present invention to provide a formulation for a fumigant that includes propargyl bromide in an active amount, and yet is non-explosive when heated.

It is another object of the present invention to provide such a formulation that will enable the use of inert solvent in the preparation stage of 3BP. This will enable safe distillation and will provide a final formulation to which antioxidant and acid scavenger are added.

All three objects are achieved both in the liquid and in the vapor state.

Other objects and advantages of the invention will become apparent as the description proceeds.

### SUMMARY OF THE INVENTION

The invention provides a composition comprising propargyl bromide (3BP) in an active concentration and comprises an environmentally acceptable solvent or mixture of solvents component that avoids the presence of dangerous amounts of pure 3BP in the liquid and in the vapor phase of the composition during the entire life cycle of the product. Thus the stability of the new mixtures designated in this invention against shock induced and/or thermally induced violent decomposition (explosion) is effective during the entire life-cycle of the material from the production stage through the handling, storage and transportation up to the application stage without fear of the possibility of concentrating the material by mistake. Active concentrations of 3BP are preferably but not limited to concentrations of at least 50%, preferably more than 65% and more preferably more than 70%, the percentages being by weight (for commercial reasons not efficacy). Dangerous amounts of 3BP in the vapors of the composition are those that are not below 95 percent by volume at a reference temperature from room temperature to 90° C., wherein the percentage for any composition is determined by the appropriate test (Recommendations on the Transport of Dangerous Goods, Manual of Tests and Criteria, 3^{rd} Edition, published by the UN, NY and Geneva, 1999 (ISBN 92-1-139068-0)).

The solvent component that avoids the presence of dangerous amounts of pure 3BP in the liquid and the vapor phase of the composition may comprise a plurality of solvents or a single solvent. However, this should not be construed as a limitation, since the presence of a solvent is included in the scope of the invention and it should be understood that the solvent could actually be a mixture of solvents, provided that such mixtures satisfy the solvent requirements that will be explained hereinafter.

When we refer to a solvent that is present in the formulation, it must be a solvent that forms an azeotrope with 3BP. Thus, no pure 3BP vapor will exist in the vapor of the composition. Some examples of such solvents that form azeotropes with 3BP will be mentioned hereinafter.

In any case the solvent or combination of solvents in the composition should preferably be in amounts at least as high as, and more preferably higher than, 5 wt %. Of course, in the single solvent composition, the solvent should preferably be present in an amount sufficient to form an azeotrope with the entire amount of 3BP present and sufficient to prevent detonation upon impact or rapid heating.

### DETAILED DESCRIPTION

In the formulated compositions (which may be briefly indicated as “1S-3BP”), as has been said, the inert solvent must be one that forms an azeotrope or azeotrope like mixture with the 3BP.

Therefore, it will be easy for skilled persons to determine whether a given solvent is suitable or not. Non-exclusive and non-limiting examples of suitable solvents are: Alkanes, such as n-Heptane, Isooctane, n-hexane, n-octane, and mixtures of Heptanes and Cyclo-hexanes, paraffinic and isoparaffinic solvent mixtures such as C7-9 hydrocarbons (Isopar C, Isopar E of ExxonMobil Chemical Corporation); Cyclo-alkanes, such as Cyclohexane and Methyl-cyclohexane; Alcohols such as 1-Propanol, Isopropyl-alcohol, Tert-butyl-alcohol and Allyl-alcohol.

A solvent that is particularly desirable for economical reasons, is Isopar C, sold by Exxon Mobil, which is mainly constituted by about 79.2 wt % of isooctane (79.14 wt %), with about 16 wt % of dimethylhexane and about 4.5 wt % of dimethylpentane, plus a minor amount of residues.

The following Table I gives the theoretically calculated azeotrope compositions and boiling temperatures of some 1S-3BP compositions and Table II gives the actual azeotrope compositions and boiling temperatures at two pressures: 80 mmHg, under vacuum, and at 755 mmHg, representing atmospheric pressure.

The amount of solvent must be at least that which will form an azeotrope with all the 3BP at the lowest temperature at which one wishes the composition to be safe during storage, transportation and use.

TABLE I
The theoretically calculated azeotrope
compositions and boiling temperatures of some 1S-3BP
compositions

| | wt % | | | |
|---|---|---|---|---|
| Solvent | Solvent | wt % 3BP | Pressures | Temp. ° C. |
| Cyclohexane | 44.8 | 55.2 | 755 mmHg | 73.8 |
| n-Heptane | 35 | 65 | 755 mmHg | 82.1 |
| n-Hexane | 68 | 32 | 755 mmHg | 65.5 |
| n-Octane | 10 | 90 | 755 mmHg | 88.4 |
| Methylcyclohexane | 33 | 67 | 755 mmHg | 83.4 |
| 1-Propanol | 24 | 76 | 755 mmHg | 83.9 |
| Isopropyl-alcohol | 43 | 57 | 755 mmHg | 75.8 |
| Tert-butyl-alcohol | 47 | 53 | 755 mmHg | 76.5 |
| Allyl-alcohol | 21 | 79 | 755 mmHg | 85 |
| Propargyl-alcohol | 0 | App. 100 | 755 mmHg | 88 |

Estimate was performed with ASPEN 11.1 Engineering Suite software via Binary Properties Analysis Option.

TABLE II
Experimentally Determined Azeotrope
Compositions and Temperatures for Propargyl Bromide
Formulation at various pressure

Experimentally
Determined Azeotrope
Compositions
and Temperatures

| System | | 80 mmHg | 755 mmHg |
|---|---|---|---|
| 1 | Propargyl Bromide* | 74.2 wt % | 77.7 wt % |
| | n-Heptane | 25.8 wt % | 22.3 wt % |
| | Temperature (° C.) | 22.4° C. | 78.8° C. |
| 2 | Propargyl Bromide* | 72.2 wt % | 78.3 wt % |
| | Methylcyclohexane | 27.8 wt % | 21.7 wt % |
| | Temperature (° C.) | 22.2° C. | 79.6° C. |
| 3 | Propargyl Bromide* | 68.5 wt % | 74.6 wt % |
| | Isooctane | 31.5 wt % | 25.4 wt % |
| | Temperature (° C.) | 20.3° C. | 78.7° C. |
| 4 | Propargyl Bromide* | 68.0 wt % | 74.1 wt % |
| | ¹Isopar C | 32.0 wt % | 25.9 wt % |
| | Temperature (° C.) | 20.8° C | 78.9° C. |
| 5 | Propargyl Bromide* | 66.1 wt % | 70.4 wt % |
| | Heptanes (mixed | 33.9 wt % | 29.6 wt % |
| | isomers)² | | |
| | Temperature (° C.) | 20.1° C. | 76.1° C. |
| 6 | Propargyl Bromide* | 49.2 wt % | 55.2 wt % |
| | Cyclohexane | 50.8 wt % | 44.8 wt % |
| | Temperature (° C.) | 18.0° C. | 72.8° C. |

*Propargyl bromide composition listed here includes a small amount of bromoallene in the azeotrope mixture.
¹Isopar C (ExxonMobil Company) is a mixture, predominately of C₈ isomers, and is about 80% isooctane
²Heptanes (VWR Chemical Company), contain (GCMS): 36.8 area % n-heptane, 27.2 area % 3-methylhexane, 19.2 area % 2-methylhexane, with the remainder being other C₇ isomers, with traces of C₆ and C₈ compounds.

1S-3BP compositions may and generally will contain, in addition to the solvent and the propargyl bromide, minor amounts of other additives, such as Epoxidized Soybean Oil (ESO), which acts as an acid scavenger, and butylated hydroxy toulene (BHT), which is a free radical inhibitor and acts as an antioxidant, and residues of by-products such as bromoallene etc.

Taking these into account, the maximum weight percentage of 3BP in the formulations may be lower than that derived from Table II and said maximum weight percentage is shown in Tables III and IV.

TABLE III
Estimated Maximum Propargyl Bromide
Concentrations in a Final Formulation

| | Estimated maximum Wt. % |
|---|---|
| Formulation | Propargyl Bromide in |
| Solvent | Final Formulation |
| Heptanes (mixed isomers) | 63-66 |
| Isopar C | 65-68 |
| Isooctane | 65-68 |
| n-Heptane | 71-74 |
| Methylcyclohexane | 71-74 |

TABLE IV
Weight percentage of actual
representative formulations:

| | Propargyl | | | |
|---|---|---|---|---|
| | bromide¹ | Solvent | BHT | ESO |
| n-Heptane | 71 | 25.5 | 0.5 | 3 |
| Isopar C | 67.5 | 31 | 0.5 | 1 |
| Cyclohexane | 77 | 19.5 | 0.5 | 3 |
| Isopar E | | | | |

¹3BP contains up to 1% impurities

The use of these kinds of mixtures (1S-3BP) for stabilizing and prevention of detonation hazards is not limited to the end product stage only. In the process of preparation of 3BP from Propargyl alcohol the use of a solvent as designated in the invention both during the reaction stage but even more-so for the distillation stage of the crude reaction mixture makes it a safer procedure since the vapor phase of the 3BP will always be accompanied by a stabilizing agent so the concentration of the 3BP would never increase above the azeotrope concentration, thereby minimizing the shock sensitivity of the vapors and making the distillation inherently safe.

### EXAMPLES

The following examples of compositions according to the invention are illustrative and not limitative. All the percentages indicated in the examples are by weight. In the 1S-3BP compositions suitable (but not limiting) solvents are Alkanes, such as n-Heptane, Isooctane, n-hexane, n-octane, and mixtures of Heptanes and Cyclo-hexanes, paraffinic and isoparaffinic solvent mixtures such as C7-9 hydrocarbons (Isopar C, Isopar E of ExxonMobil Chemical Corporation); Cyclo-alkanes, such as Cyclohexane and Methyl-cyclohexane; Alcohols such as 1-Propanol, Isopropyl-alcohol, Tert-butyl-alcohol and Allyl-alcohol.

### Example 1

A particular case of the formulation is given in the following (one inert solvent formulation)

71% Propargyl Bromide

25.5% n-Heptane

0.5% BHT

3.0% ESO

The composition of Example 1 forms an azeotrope, the composition of which is given in Table I.

### Example 2

### Mixture of Solvents Formulation

67.5% Propargyl bromide

31% Isopar C

1% ESO

0.5% BHT

Both solvents are present in percentages by weight that are required for the safe handling of the 3BP. Example 2 takes the entire solvent mixture added as one. The compositions may contain the same additives, such as ESO and BHT. The content of propargyl bromide in both compositions is preferably higher than 65 wt %.

### Example 3

Distillation of 3BP under reduced pressure simulating a crude reaction mixture containing toluene as solvent starting with adding to the mixture the solvent of choice e.g. Isopar C (ExxonMobil solvent contains mixture of mainly C8 isomers (80% isooctane)) led to an azeotrope of 69% propargyl bromide and 31% Isopar C. The same procedure can be achieved with the other solvents e.g. cyclohexane etc. This enables the final distillation stage of the preparation process to be inherently safe and can lead to the final desired composition for the final formulation (except for the additives).

### Example 4

The following tests were carried out on different formulation compositions and the preferred formulation of Example 2.

Results concerning the safety issues for transportation and handling the Propargyl bromide were rechecked independently by Chilworth Technology, Inc.—A Professional Process Safety Firm, NJ 08852.

Flammability/Electrostatic Hazard Testing Results:

Flammability Testing:

Flash point: −11° C.

Autoignition Temp. (At atmospheric pressure) 263-266° C. (As per ASTM E-659)

Autoignition Temp. (At 50 psig pressure) 240-242° C. (As per ASTM E-659)

Lower Flammable Limit 1.5-2.0% vol

Upper Flammable Limit 7.2-15.8% vol

Limiting Oxygen Concentration (Nitrogen/Air) 12.0-13.0%

Maximum experimental safe gap >1 mm

Electrostatic Hazards:

MIE (Minimum Ignition Energy) of vapor 0.5-1.0 mJ

Liquid conductivity 1.1X10E4 pS/m (pSiemens/m)

Based upon these results the material should be considered a Class IB Flammable Liquid with NEC (National Electrical Code) Group D equipment rating.

Transportation Testing Results:

UN Test Series 3: Drop Impact

Test 3(a) (i)—Bureau of Explosives (BOE) Impact Machine:

This test measures the sensitiveness of a substance to drop-weight impact, and simulates momentum transfer events that may occur in transportation accidents. Two types of impact testers were used: The US Bureau of Explosives (BOE) test was performed with a 3.63 kg weight dropped from a height of 25.4 cm ten times. Ten trials were performed, and a test failure is classified as one resulting in at least one occurrence of decomposition. While neat propargyl bromide failed the BOE test, with 9 decompositions in 10 trials, the single solvent formulation of Example 2 passed the test.

The US Bureau of Mines (BOM) test was performed from two separate drop heights of 15 cm and 30 cm, and for samples from two separate sources (India and Fluka, respectively), and the single solvent formulation of Example 2 passed the test.

Test 3(a)(ii)—BAM Fallhammer Test

This test is also used to measure the sensitiveness of a substance to drop-weight impact and to determine if the substance is too dangerous to transport in the form test. Again the single solvent formulation of Example 2 passed the test.

Test 3(c)—Thermal Stability Test at 75° C.

This test is used to measure the stability of the test substance when subjected to elevated external temperatures. Again the single solvent formulation of Example 2 passed the test.

Test 3(d)—Small Scale Burning Test

This test is used to determine the response of the test substance to an external fire. Again the single solvent formulation of Example 2 passed the test.

Conclusion of UN Tests Series 3 Results:

The test series 3 results confirm that the neat Propargyl bromide samples are considered too sensitive to mechanical impact to allow transportation, while the formulations developed passed all the tests in series 3.

UN Test Series 1: for determining whether the substance should be considered explosive.

Test 1(a)—UN Gap Test:

This test is used to measure the ability of a substance under confinement in a steel tube to propagate a detonation by subjecting it to a detonation from a booster charge. The formulation of Example 2 passed the test (zero gap with air cavitation).

Test 1(b)—Koenan Tube Test

This test determines the sensitivity to intensive heating under confinement and simulates the behavior of the material when subjected to high temperatures, such as in a fire. The apparatus used for the testing is a tube with a fixed size orifice which allows the contents to escape during intense heating. The test is considered a failure if a violent effect, such as tube fragmentation, is observed for a limiting diameter of 1.0 mm or more. The formulation of Example 2 passed the test with no damage to the tube at an orifice size of 1 mm.

Test 1(c) (i)—Time-Pressure Test

This test determines the effect of igniting the substance under confinement to determine whether such ignition leads to a deflagration with explosive violence. Pyrotechnic material is ignited inside a tube in which the sample has been placed. If the pressure within the tube rises to at least 2070 kPa (300 psi), the substance is considered to have the ability to deflagrate. If the time lapse between achieving 690 kPa (100 psi) and 2070 kPa (300 psi) is greater than 30 miliseconds (ms), then the substance does not have the ability to rapidly deflagrate. A failure of this test occurs for a substance that rapidly deflagrates, i.e. there is a pressure rise to 2070 kPa in less than 30 ms, in at least one out of three trials. The formulation of Example 2 completely passed this test.

Adiabatic Compression Test

This test determines the initiation sensitivity of the material to sudden gas compression, such as liquid inertia compressing entrained gas bubbles during transportation or hydrostatic pressure heads which form when pumping liquid or opening and closing valves. The test is performed with a plunger to rapidly compress gas from a drop height of at least 100 cm within a cylindrical chamber containing the sample. Energy is delivered to the plunger with a drop weight. A failed test is one in which any smoke, discoloration, char, spark or audible report result from the test. Neat propargyl bromide and the single solvent formulation pass the test at drop height of 150 cm in nitrogen and fail the test in air at drop heights of 100 cm and 150 cm.

Conclusion from UN Test Series 1 Results:

The single solvent formulation successfully passed UN Test Series 1 and should not be considered an explosive substance with respect to transportation.

On top of all these tests some Thermal Analysis tests were studied e.g.

DSC—Differential Scanning Calorimetry and Advanced Reactive System Screening Tool (ARSST)—Both the onset temperature and maximum heat output rate temperature were recorded. If the onset exotherm is less than 100□C, the material is regarded as being too hazardous to ship. The onset and exothermic peak temperature results for the propargyl bromide formulations test were well inside the desirable limits (>170° C. and 245° C. respectively).

The use of these formulations as fumigants can be the same as methyl bromide i.e. the “shank injection” method or via other known methods e.g. through dripping irrigation systems with or without the use of an emulsifying agent.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A stabilized composition of propargyl bromide comprising said propargyl bromide in combination with an azeotropic solvent mixture for diluting said propargyl bromide and preventing shock or temperature sensitivity throughout the life cycle of said propargyl bromide.

2. A composition for controlling soil-born pests comprising an active concentration of propargyl bromide in combination with an inert solvent in an amount sufficient to avoid the presence of predetermined levels of said propargyl bromide both in the liquid and vapor phases thereof.

3. The composition of claim 1 wherein said active concentration of said propargyl bromide is at least about 50 wt. %.

4. The composition of claim 3 wherein said active concentration of said propargyl bromide is at least about 65 wt %.

5. The composition of claim 4 wherein said active concentration of said propargyl bromide is greater than about 65 wt. %.

6. The composition of claim 1 wherein said amount of said inert solvent is sufficient to maintain said vapor phase to include less than 95% by volume of said propargyl bromide at a predetermined temperature between room temperature and 90° C.

7. The composition of claim 1 wherein said inert solvent comprises a plurality of solvents.

8. The composition of claim 1 wherein said inert solvent comprises two solvents.

9. The composition of claim 1 wherein said inert solvent comprises a single solvent.

10. The composition of claim 9 wherein said solvent forms an azeotrope with said propargyl bromide.

11. The composition of claim 7 wherein said plurality of solvents mimics an azeotrope-like formulation that will act as an azeotrope with said propargyl bromide.

12. The composition of claim 7 wherein said plurality of solvents forms an azeotrope with said propargyl bromide.

13. The composition of claim 7 wherein said plurality of solvents comprises a mixture of solvents.

14. The composition of claim 7 including at least about 5 wt. % of said solvent.

15. The composition of claim 9 wherein said solvent is present in an amount sufficient to form an azeotrope with the entire amount of said propargyl bromide present in said composition.

16. The composition of claim 10 wherein said solvent is selected from the group consisting of alkanes, cycloalkanes, alcohols, and paraffinic and isoparaffinic solvent mixtures.

17. The composition of claim 16 wherein said alkanes are selected from the group consisting of n-heptane, isooctane, n-hexane, n-octane, and mixtures of heptanes and cyclohexanes.

18. The composition of claim 16 wherein said cycloalkanes are selected from the group consisting of cyclohexane and methyl-cyclohexane.

19. The composition of claim 16 wherein said alcohols are selected from the group consisting of 1-propanol, isopropyl-alcohol, tert-butyl-alcohol, and allyl-alcohol.

20. The composition of claim 16 wherein said paraffinic and isoparaffinic solvent mixtures comprise C7 through C9 hydrocarbons.

21. The composition of claim 10 wherein said solvent is selected from the group consisting of n-heptane, isooctane, mixtures of heptanes and cyclohexanes, cyclohexane, and methyl-cyclohexane.

22. A method for the stabilization of propargyl bromide comprising diluting said propargyl bromide with an azeotropic solvent mixture whereby shock and temperature sensitivity are prevented throughout the life cycle of said propargyl bromide.

23. A method for the stabilization of propargyl bromide comprising adding an inert solvent to said propargyl bromide in an amount sufficient to avoid the presence of predetermined levels of said propargyl bromide both in the liquid and vapor phases thereof.

24. The method of claim 23 wherein said inert solvent is selected from the group consisting of alkanes, cycloalkanes, alcohols, and paraffinic and isoparaffinic solvent mixtures.

25. The method of claim 24 wherein said alkanes are selected from the group consisting of n-heptane, isooctane, n-hexane, n-octane, and mixtures of heptanes and cyclohexanes.

26. The method of claim 24 wherein said cycloalkanes are selected from the group consisting of cyclohexane and methyl-cyclohexane.

27. The method of claim 24 wherein said alcohols are selected from the group consisting of 1-propanol, isopropyl-alcohol, tert-butyl-alcohol, and allyl-alcohol

28. The method of claim 24 wherein said paraffinic and isoparaffinic solvent mixtures comprise C7 through C9 hydrocarbons.
